(19) United States
(12) Patent Application Publication
(10) Pub. No.: US 2010/0273451 A1
(43) Pub. Date: Oct. 28, 2010

(54) Method and Apparatus for Mobile Terminal Positioning Operations

(76) Inventors: Joakim Bergström, Stockholm (SE); Kenneth Balck, Linkoping (SE); Ake Busin, Sollentuna (SE); Tao Cui, Stockholm (SE); Martin Israelsson, Spanga (SE); Tarmo Kuningas, Sollentuna (SE); Janne Peisa, Espoo (FI); Elena Voltolina, Jarfalla (SE)

Correspondence Address: COATS & BENNETT, PLLC, 1400 Crescent Green, Suite 300, Cary, NC, 27518, US

(21) Appl. No.: 12/493,598

(22) Filed: Jun. 29, 2009

Related U.S. Application Data
(60) Provisional application No. 61/173,333, filed on Apr. 28, 2009.

(51) Int. Cl. H04W 24/00; H04M 1/00

(52) U.S. Cl. 455/411; 455/456.2; 455/550.1

(57) ABSTRACT

In one aspect of the invention presented herein, a mobile terminal requests positioning assistance data from its supporting wireless communication network, in response to receiving a positioning request from a positioning node. Further, in response to receiving the positioning assistance data from the network, the mobile terminal sends the positioning assistance data to the positioning node. In this manner, the positioning node advantageously gains access to network-generated positioning assistance data without need for requesting it from the network. In at least one embodiment, the mobile terminal receives the positioning request from the positioning node over a User Plane (UP) connection. However, the mobile terminal sends the positioning assistance data request to the base station over a Control Plane (CP) connection, and receives the requested positioning assistance data via the CP. The terminal transfers that data to the UP and sends it to the positioning node.

### RELATED APPLICATIONS

This application claims priority from the U.S. provisional patent application filed on 28 Apr. 2009 and assigned Application No. 61/173,333, and which is incorporated herein by reference.

### TECHNICAL FIELD

The present invention generally relates to mobile terminal positioning operations, and particularly relates to providing network-generated positioning assistance data for use in such operations.

### BACKGROUND

Mobile terminal location services support public safety applications (e.g., emergency location services), as well as a range of commercial applications (e.g., locality-based advertising, etc.). The types of location based services available vary in dependence on the types and capabilities of the involved wireless communication networks and mobile terminals, but those skilled in the art will appreciate that there is significant and growing interest in deploying and supporting various location based services. That interest implicates several aspects of wireless communication operations in developing types of networks, such as those based on the Long Term Evolution (LTE) standards promulgated by the Third Generation Partnership Project (3 GPP).

The “Secure User Plane for Location” (SUPL) standards define a User Plane (UP) solution for positioning in such networks. According to the SUPL provisions, a SUPL Enabled Terminal (SET) communicates directly with a SUPL Location Platform (SLP). Within this framework, the SLP sends positioning requests to the SET over a UP connection established between the SLP and the SET. The SET responds directly to the SPL, again using the UP connection between them.

One disadvantage of this arrangement is that the positioning request from the positioning node and the return response from the SET are transparent to the underlying wireless communication network, as they are carried as user traffic over the UP connection. Consequently, the network is not triggered or otherwise requested to provide network-determined positioning assistance data to the SET and/or the SLP.

The general desirability of having certain network-based positioning assistance data available in user equipment (UE) is known. For example, the document R1-091665, as presented by NOKIA SIEMENS NETWORKS at the 3GPP TSG RAN WG1 Meeting #56bis in Seoul, Korea (23-27 Mar. 2009), identifies the usefulness of the LTE network providing to a UE assistance data for Observed Time Difference of Arrival (OTDOA) positioning techniques. The document notes that such information can improve the UE's neighbor cell detection performance and help achieve a sufficiently high positioning yield—i.e., the probability of detecting at least two cells from two other eNodeBs in the LTE network.

The document expresses an expectation that the following information will be useful in the UE: the physical Cell IDs of candidate cells in the network, along with transmission timing of the candidate cells relative to the serving cell transmission timing. Finally, the document indicates that the foregoing information must be known by the network for triangulation of the UE's position and that the provision of such information to the UE will aid neighbor cell detection by the UE.

### SUMMARY

According to one aspect of the present invention, a mobile terminal requests positioning assistance data from its supporting wireless communication network, in response to receiving a positioning request from a positioning node. Further, in response to receiving the requested positioning assistance data from the network, the mobile terminal sends the positioning assistance data to the positioning node. In this manner, the positioning node advantageously gains access to network-generated positioning assistance data without need for requesting it from the network.

In particular, in at least one embodiment, the communications between the positioning node and the mobile terminal are carried on a User Plane (UP) connection and thus are transparent to the supporting wireless communication network. However, the mobile terminal is configured to request the positioning assistance data from the network over a Control Plane (CP) connection between the mobile terminal and a serving base station in the network. Correspondingly, the network returns the requested positioning assistance data to the mobile terminal via one or more messages sent over the CP connection. Advantageously, the mobile terminal transfers the positioning assistance data from the CP to the UP, and transmits it to the positioning node.

In at least one such embodiment, the positioning node operates according to Secure User Plane for Location (SUPL) protocols and definitions—see OMA-AD-SUPL V2_{—}0-20080521-D, as promulgated by the OPEN MOBILE ALLIANCE. In particular, the positioning node is a SUPL Location Platform (SLP), and the mobile terminal is a SUPL Enabled Terminal (SET). In this framework, the SET requests positioning assistance data from the underlying network (i.e. a supporting LTE network), and provides it to the SLP. Thus, the SLP does not need to request the assistance data from the underlying network.

As an example, when the SET receives a location request for OTDOA positioning from the SLP, the SET sends a request to its serving eNodeB in the LTE network, requesting the required OTDOA assistance data. The communication between the SET and the eNodeB is carried out in the CP, e.g., using Radio Resource Control (RRC) signaling. To advantageously support SET-assisted positioning, the SET forwards the assistance data it received from the network via CP signaling, to the SLP using the User plane Location Protocol (ULP) defined in SUPL. The SET is configured to internally transfer the CP-received positioning assistance data from the CP to the UP, and to forward that positioning assistance data over the UP (in the uplink) to the SLP.

Further, in one or more embodiments, a security key, or a derived value generated from the security key, is used to prevent unauthorized usage of network-generated assistance data. For example, the network operator or the positioning node provider (e.g., an SLP provider) issues a security key for use between the mobile terminal and the supporting wireless communication network. In at least one such embodiment, the mobile terminal stores the security key and sends it (or a derived value) in conjunction with requesting positioning assistance data from the network. In turn, the network selectively generates or otherwise obtains the requested assistance data based on verifying the key. As such, return of the requested assistance data by the network to the mobile terminal is conditioned on verification of the key.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a wireless communication network according to the teachings presented herein.

FIG. 2 is a block diagram of one embodiment of User Plane (UP) and Control Plane (CP) signaling between a mobile terminal, a base station, and a positioning node external to the network.

FIG. 3 is a block diagram of example embodiments of a mobile terminal and a base station.

FIG. 4 is logic flow diagram of one embodiment of mobile terminal processing, for supporting mobile terminal positioning operations.

FIG. 5 is a logic flow diagram of one embodiment of base station processing, for supporting mobile terminal positioning operations.

FIG. 6 is a signal/call flow diagram, illustrating one embodiment of mobile terminal positioning, for a SET, a SLP, and an LTE eNodeB.

### DETAILED DESCRIPTION

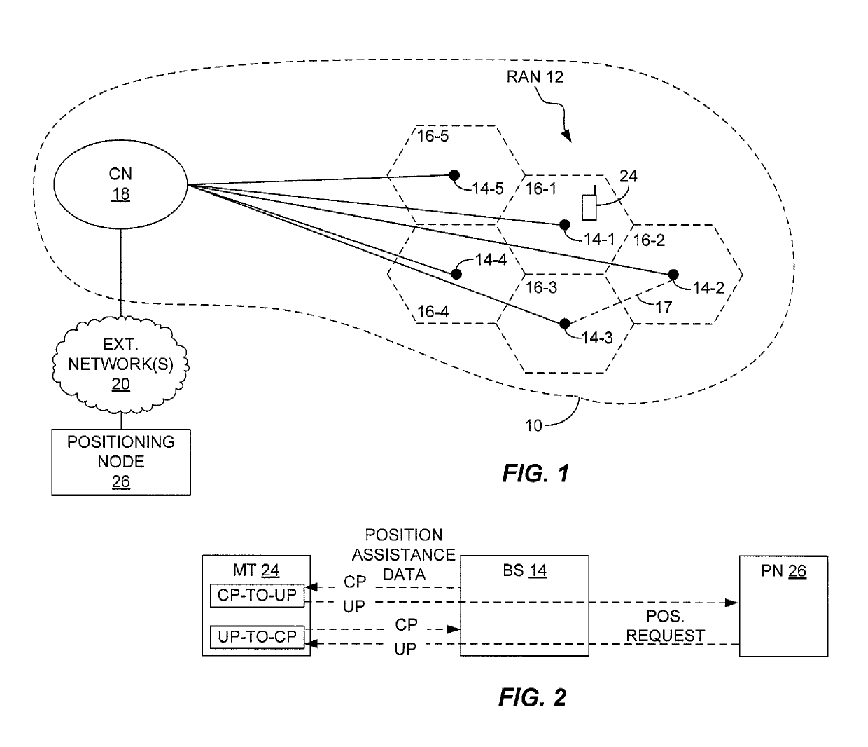

FIG. 1 illustrates an example embodiment of a wireless communication network 10, which, by way of non-limiting example, comprises a Long Term Evolution (LTE) network. As depicted, the network 10 includes a Radio Access Network (RAN) 12, comprising a number of base stations 14 e.g., eNodeBs in an LTE embodiment. The base stations 14 are shown as 14-1, 14-2, and so on, and they define corresponding service areas or “cells” 16, which are numbered as 16-1, 16-2, and so on. Individual base stations 14 may be communicatively coupled together via a base station communication interface 17, such as an “X2” interface in LTE embodiments.

The base stations 14 are also communicatively coupled to a Core Network (CN) 18. In turn, the CN 18 is coupled to one or more external networks 20, such as the Internet and/or the Public Switched Telephone Network (PSTN). As is well understood by those of ordinary skill in the art, this arrangement communicatively couples mobile terminals 24 to other systems and devices accessible through the external network(s) 20, such as a positioning node 26, which is of particular interest herein. For simplicity, only one mobile terminal 24 is shown, operating within the cell 16-1 of the RAN 12. However, those skilled in the art will appreciate that a potentially large plurality of mobile terminals 24 may operate within the network 10, and they will further appreciate that the network diagram is simplified in other non-germane respects, for ease of discussion.

As shown in FIG. 2, the mobile terminal (MT) 24 and base station (BS) 14 are advantageously configured to support mobile terminal positioning operations, as relates to the positioning node (PN) 26. Specifically, according to the teachings presented herein, the mobile terminal 24 and the base station 14 are configured to provide the positioning node 26 with network-generated positioning assistance data for the mobile terminal 24, without requiring explicit connections/communications between the network 10 and the positioning node 26.

As shown in FIG. 2, the positioning node 26 sends a positioning request to the mobile terminal 24 over a User Plane (UP) connection between the positioning node 26 and the mobile terminal 24. The UP connection is, of course, supported by network 10, specifically by the wireless communication link (air interface) between the mobile terminal 24 and the RAN 12/base station 14. However, signaling flowing on the UP connection between the mobile terminal 24 and the positioning node 26 passes transparently as user traffic through the network 10.

Thus, the positioning node's positioning request is directed to the mobile terminal 24, and not to the network 10. Advantageously, however, the mobile terminal 24 enhances the positioning information it provides to the positioning node 26 in response to the request by obtaining network-generated positioning assistance data.

The mobile terminal 24 does so by sending a positioning assistance data request to the base station 14 via its Control Plane (CP) connection with the base station 14. In turn, the base station 14 generates or otherwise obtains network-generated positioning assistance data—e.g., Observed Time Difference of Arrival (OTDOA) data—and sends that data to the mobile terminal 24 via the CP connection. In response to receiving the positioning assistance data from the base station 14 via the CP connection, the mobile terminal 24 transfers that data to the UP, and transmits it to the positioning node 26 via the UP connection. As such, the positioning node 26 is provided with network-generated positioning assistance data, which can greatly improve positioning determination operations, without need for requesting such data from the network 10.

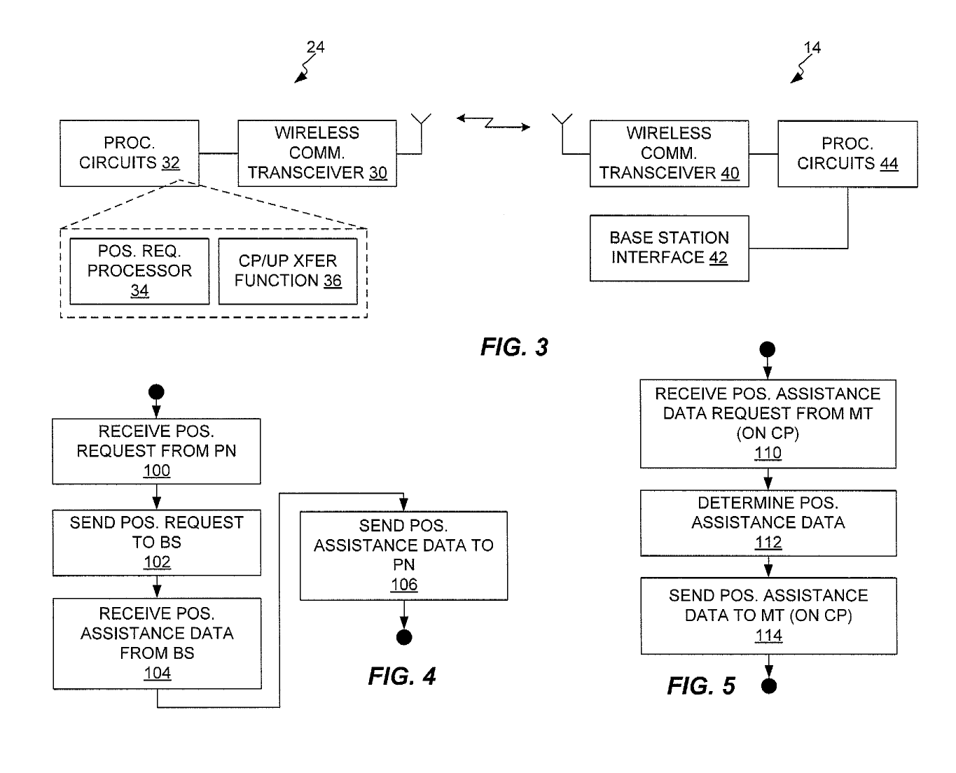

FIG. 3 depicts example embodiments of the mobile terminal 24 and the base station 14. The illustrated mobile terminal 24 is configured to support the above-described mobile terminal positioning operations and it comprises a wireless communication transceiver 30 that is configured to send signals to the network 10, and to receive signals from the network 10. Further, the mobile terminal 24 comprises one or more processing circuits 32 that are operatively associated with the transceiver 30. Advantageously, the processing circuits 32 are configured to receive a positioning request sent from the positioning node 26 via the network 10, and send a positioning assistance data request to the network 10, in response to receiving the positioning request. The processing circuits 32 are further configured to receive positioning assistance data from the network 10, in response to sending the positioning assistance data request, and to send the positioning assistance data to the positioning node 26.

In one embodiment, the one or more processing circuits 32 of the mobile terminal 24 are configured to receive the positioning request over UP connection between the mobile terminal 24 and the positioning node 26, as supported by the network 10. In at least one such embodiment, the one or more processing circuits 32 of the mobile terminal 24 are configured to send the positioning assistance data request over a CP connection between the mobile terminal 24 and a (serving) base station 14 in the network 10.

A serving base station 14/serving cell 16 is the particular base station 14/cell 16 that is currently providing communications service to the mobile terminal 24. Those skilled in the art will appreciate that the serving base station changes over time, with changing radio conditions and/or mobile terminal position, and that, at any given time, a cluster of several neighboring base stations 14/cells 16 may be candidates for serving the mobile terminal 24.

In any case, in at least one embodiment, the one or more processing circuits 32 of the mobile terminal 24 are configured to receive the positioning assistance data from the base station 14 over the CP connection, transfer the positioning assistance data from the CP to the UP, and transmit it to the positioning node 26 over the UP. Further, in at least one embodiment, the one or more processing circuits 32 of the mobile terminal 24 are configured to request a particular type of positioning assistance data via the positioning assistance data request, based on determining the particular type of positioning assistance data needed for the positioning request received from the positioning node 26.

In one such embodiment, the positioning request from the positioning node 26 is an Observed Time Difference of Arrival (OTDOA) based positioning request that is received over the UP connection between the mobile terminal 24 and the positioning node 26. Correspondingly, the processing circuits 32 of the mobile terminal 24 are configured to send the positioning assistance data request as one or more CP messages to the serving base station 14 in the network 10, requesting OTDOA assistance data for the mobile terminal 24 from the serving base station 14. For example, the one or more CP messages comprise one or more Radio Resource Control (RRC) protocol messages, or one or more messages sent using a positioning (message) protocol on top of the RRC protocol.

In correspondence with requesting OTDOA based positioning assistance data, the one or more control circuits 32 of the mobile terminal 24 are configured to receive the positioning assistance data as one or more CP messages that include physical cell identifications (PCIs) for a number of candidate cells 16 in the network 10. The returned information further includes transmission timing information for the candidate cells 16 relative to serving cell transmission timing, wherein the serving cell 16 corresponds to the serving base station 14. The mobile terminal 24 returns the PCIs and associated timing information to the positioning node 26.

In the same or other embodiments, positioning operations are secured by use of a security key or other authentication data. The security key may be issued by the network operator, or by a location services operator associated with the positioning node 26, and it may be stored in the mobile terminal 24 and/or included in associated subscriber information accessible to the network 10. In at least one such embodiment, the mobile terminal 24 includes a memory storing the security key, and the one or more processing circuits 32 of the mobile terminal 24 are configured to include the security key, or a derived value based on the security key, in the positioning assistance data request sent to the network 10. Doing so satisfies the network-imposed access restrictions to the requested positioning assistance data. With this arrangement, mobile terminals not having access to the correct security information would not be able to obtain the network-generated positioning assistance data.

For this and other embodiments, those skilled in the art will appreciate that the mobile terminal's processing circuits 32 may comprise dedicated hardware circuits, or programmable circuitry configured, e.g., by the execution of stored computer program instructions, or some mix of the two. For example, in at least one embodiment, the processing circuits 32 include a positioning request processor 34, which implements or is associated with a CP/UP transfer (XFER) function 36. That is, the positioning request processor 34 is configured to transfer the positioning assistance data (as received from the base station 14) from the CP to the UP, for forwarding to the positioning node 26 over the mobile terminal's UP connection.

The processing circuits 32 in one or more embodiments include at least one microprocessor-based circuit, and associated memory, or other computer-readable medium, for storing a computer program for execution by the microprocessor-based circuit. Such execution specially adapts or otherwise configures the microprocessor-based circuit to carry out a method such as that shown in FIG. 4, wherein the mobile terminal's processing includes receiving a positioning request from the positioning node 26 (Block 100), and correspondingly sending a positioning assistance data request to the (serving) base station 14 (Block 102). The illustrated processing continues with the mobile terminal 24 receiving the requested positioning assistance data from the base station 14 (Block 104), and sending that data to the positioning node (Block 106).

Referring again to FIG. 3, one sees an embodiment of the base station 14, for supporting the base station side of such processing. The illustrated base station 14 is configured to support mobile positioning operations and comprises a wireless communication transceiver 40, for sending wireless communication signals to mobile terminals 24 and receiving wireless communication signals from mobile terminals 24. The base station 14 further includes a base station interface circuit 42, for communicating with one or more other base stations (see the inter-base station interface 17 of FIG. 1), and further includes one or more processing circuits 44 that are operatively associated with the transceiver 40.

The processing circuits 44 are configured to receive a positioning assistance data request from a mobile terminal 24 over a CP connection with the mobile terminal 24, and to determine positioning assistance data for the mobile terminal 24 in response to the positioning assistance data request. Further, the processing circuits 44 are configured to send the positioning assistance data to the mobile terminal 24 over the CP connection.

In one or more embodiments, the processing circuits 44 of the base station 14 are configured to determine the positioning assistance data selectively, based on verifying authentication data included in the positioning assistance data request, and to send the positioning assistance data to the mobile terminal 24 conditioned on successful verification of the authentication data. For example, the earlier-mentioned security key (or derived value) is provided by the mobile 24 as part of the positioning assistance data request, and the base station 14 returns the requested positioning assistance data only if the security key, or derived value, is successfully verified.

Further, as noted, in at least one embodiment, the positioning assistance data request is a request for OTDOA assistance data, and it is received at the base station 14 via one or more CP messages sent from the mobile terminal 24. Accordingly, the one or more processing circuits 44 of the base station 14 are configured to determine the positioning assistance data based on determining or obtaining OTDOA assistance data for the mobile terminal 24, for the base station 14 as the mobile terminal's serving cell 16, and for base stations 14 in one or more neighboring candidate cells 16. The base station 14 is further configured to send the OTDOA assistance data to the mobile terminal 24 as the requested positioning assistance data, via one or more CP messages sent from the base station 14 to the mobile terminal 24.

Still further, in at least one such embodiment, the OTDOA assistance data includes physical cell identifications (PCIs) for the candidate cells 16 and transmission timing information for the candidate cells 16 relative to serving cell transmission timing. (Such data supports accurate location of the UE with respect to known base station locations.) In such embodiments, the base station 14 is configured to obtain at least some of the OTDOA assistance data from the candidate cells 16 via inter-base-station communications carried between the base station 14 (as the mobile terminal's serving base station) and the one or more neighboring base stations 14 on the base station interface 17.

As with the mobile terminal 24, those skilled in the art will appreciate that the processing circuits 44 of the base station 14 also may comprise dedicated hardware, or programmable circuitry configured via the execution of stored program instructions, or both. In at least one embodiment, the processing circuits 44 include one or more microprocessor-based circuits and the base station 14 includes memory or another computer-readable medium (disks, etc.) storing a computer program, the execution of which configures the one or more processing circuits 44 for the base station side of the positioning operations described herein.

FIG. 5 illustrates one embodiment of such processing, wherein the illustrated operations include receiving a positioning assistance data request from a mobile terminal 24 (Block 110). The request is received via the CP connection between the base station 14 and the mobile terminal 24. Processing continues with the base station 14 determining the positioning assistance data (Block 112). As noted, such processing may be conditioned on successful verification that the mobile terminal 24 is authorized to gain access to network-generated positioning assistance data.

The data generated is, in one or more embodiments, OTDOA assistance data that includes the PCIs of one or more candidate cells 16, along with transmission timing information for those candidate cells 16 relative to the serving cell's transmission timing. Such data aids mobile terminal operations, including neighboring cell detection, and enables or otherwise improves the positioning determination at issue with respect to the positioning node 26.

The illustrated processing continues with the base station 14 sending the requested positioning assistance data to the mobile terminal 24 (Block 114). In particular, the data is sent from the base station 14 to the mobile terminal 24 on the CP. For example, the base station 14 sends one or more RRC messages to the mobile terminal 24, or, as another example, sends the data using a protocol extension of the underlying RRC protocol.

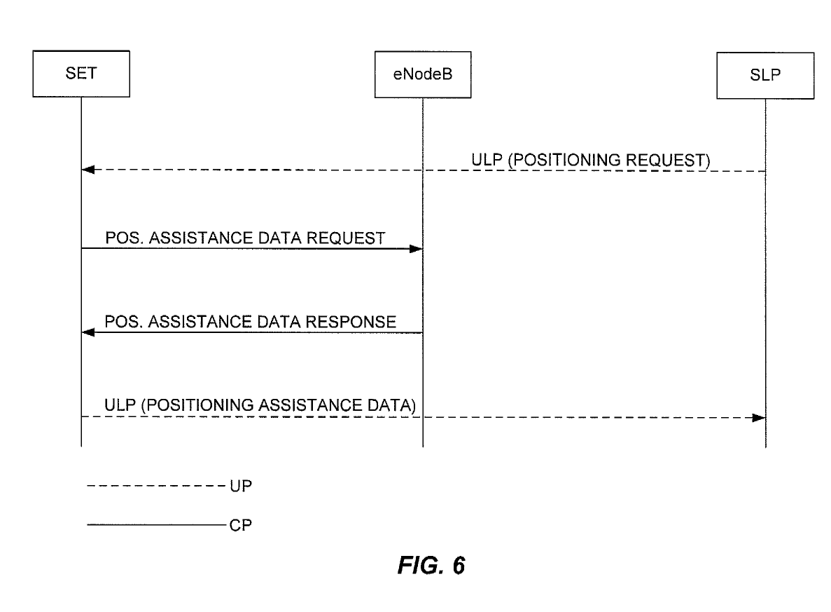

FIG. 6 illustrates another example of the above-described processing, this time in the specific context of Secure User Plane for Location (SUPL) operations, as described in the OPEN MOBILE ALLIANCE document OMA-AD-SUPL V2_{—}0-20080521-D (SUPL V2.0). In this context, the mobile terminal 24 is shown as a SUPL Enabled Terminal (SET) and the base station 14 is shown as an LTE network eNodeB. Further, the positioning node 26 is shown as an SLP (SUPL Location Platform).

As those skilled in the art will appreciate, SUPL V2.0 defines the protocol used between a SET and a SLP. As taught herein, positioning operations are enhanced by providing network-generated positioning assistance data to the SLP, based on the SET obtaining such data from the eNodeB over the CP connection, and sending it to the SLP over the UP connection. FIG. 6 illustrates a proposed message flow for such operations.

In the diagram, the dashed lines represent transmissions in the UP, while solid lines represent transmissions in the CP. As shown, a positioning request is received in the SET from the SLP. The request is received on the UP connection between the SET and the SLP. Having received the request, the SET recognizes what assistance data is needed, depending upon the selected positioning method.

If eNodeB related assistance data are needed, as is the case for OTDOA based positioning, the SET sends a request for such data to the eNodeB. The positioning assistance data request message could be either an integral part of the RRC protocol, or could be sent using a positioning protocol on top of the RRC protocol. In either case, the eNodeB responds with the assistance data as specified in the request. If all the requested assistance data are not available in the serving eNodeB, the serving eNodeB sends requests to neighboring eNodeBs to provide the additionally needed information. Such requests preferably are sent over the X2 interface between the eNodeBs.

The serving eNodeB then collects all the information and forwards it to the SET, as the response to the SET's positioning assistance data request. For SET assisted positioning, the positioning assistance data received at the SET from the serving eNodeB is transferred from the CP to the UP and forwarded to the SLP. Such forwarding may use secured signaling. Also, it should be noted that, for SET based position determinations, the SET uses the positioning assistance data received from the serving eNodeB to calculate the SET's position.

Also, as discussed earlier, the operator of the network 10 may wish to restrict exposure of the above-mentioned positioning assistance data to the SUPL service provider. The SET's request for assistance data may thus be configured to include a secure key that the eNodeB checks before granting access to the positioning assistance data. As examples, the secure key may be provisioned as subscriber data, or provisioned in the eNodeB.

The above operations can be applied in case of other network-based positioning assistance data types, e.g. Angle of Arrival data. Further, as detailed earlier herein, the above operations may be adapted for non-SUPL applications.

As such, those skilled in the art will appreciate that the present invention is not limited by the foregoing description, or by the accompanying drawings. Instead, the present invention is limited only by the following appended claims and their legal equivalents.

What is claimed is:

1. A method in a mobile terminal of supporting mobile terminal positioning operations, said method comprising:
receiving a positioning request sent from a positioning node via a wireless communication network supporting the mobile terminal;
sending a positioning assistance data request to the wireless communication network, in response to receiving the positioning request;
receiving positioning assistance data from the wireless communication network, in response to sending the positioning assistance data request; and
sending the positioning assistance data to the positioning node.

2. The method of claim 1, wherein receiving the positioning request comprises the mobile terminal receiving the positioning request over a User Plane (UP) connection between the mobile terminal and the positioning node, as supported by the wireless communication network.

3. The method of claim 2, wherein sending the positioning assistance data request comprises the mobile terminal sending the positioning assistance data request over a Control Plane (CP) connection between the mobile terminal and a serving base station in the wireless communication network.

4. The method of claim 3, wherein receiving the positioning assistance data comprises the mobile terminal receiving the positioning assistance data over the CP connection, and wherein sending the positioning assistance data comprises the mobile terminal transferring the positioning assistance data from the CP to the UP, and transmitting the positioning assistance data over the UP, to the positioning node.

5. The method of claim 1, wherein the mobile terminal requests a particular type of positioning assistance data in the positioning assistance data request based on determining the particular type of positioning assistance data needed for the positioning request received from the positioning node.

6. The method of claim 1, wherein the positioning request from the positioning node is an Observed Time Difference of Arrival (OTDOA) based positioning request received over a User Plane (UP) connection between the mobile terminal and the positioning node, and wherein sending the positioning assistance data request comprises the mobile terminal sending one or more Control Plane (CP) messages to a serving base station in the wireless communication network, requesting OTDOA assistance data for the mobile terminal from the serving base station.

7. The method of claim 6, wherein receiving the positioning assistance data comprises the mobile terminal receiving one or more CP messages that include physical cell identifications (PCIS) for a number of candidate cells in the wireless communication network, and further include transmission timing information for the candidate cells relative to serving cell transmission timing, wherein the serving cell corresponds to the serving base station.

8. The method of claim 1, further comprising including a security key, or a value derived from the security key, in the positioning assistance data request, to thereby satisfy network-imposed access restrictions to the requested positioning assistance data.

9. A mobile terminal configured to support mobile terminal positioning operations, said mobile terminal comprising:
a wireless communication transceiver configured to send signals to a wireless communication network, and to receive signals from the wireless communication network; and
one or more processing circuits operatively associated with the wireless communication transceiver and configured to:
receive a positioning request sent from a positioning node via the wireless communication network;
send a positioning assistance data request to the wireless communication network, in response to receiving the positioning request;
receive positioning assistance data from the wireless communication network, in response to sending the positioning assistance data request; and
send the positioning assistance data to the positioning node.

10. The mobile terminal of claim 9, wherein the one or more processing circuits of the mobile terminal are configured to receive the positioning request over a User Plane (UP) connection between the mobile terminal and the positioning node, as supported by the wireless communication network.

11. The mobile terminal of claim 10, wherein the one or more processing circuits of the mobile terminal are configured to send the positioning assistance data request over a Control Plane (CP) connection between the mobile terminal and a serving base station in the wireless communication network.

12. The mobile terminal of claim 11, wherein the one or more processing circuits of the mobile terminal are configured to receive the positioning assistance data over the CP connection, transfer the positioning assistance data from the CP to the UP, and transmit the positioning assistance data over the UP, to the positioning node.

13. The mobile terminal of claim 9, wherein the one or more processing circuits of the mobile terminal are configured to request a particular type of positioning assistance data via the positioning assistance data request, based on determining the particular type of positioning assistance data needed for the positioning request received from the positioning node.

14. The mobile terminal of claim 9, wherein the positioning request from the positioning node is an Observed Time Difference of Arrival (OTDOA) based positioning request received over a User Plane (UP) connection between the mobile terminal and the positioning node, and wherein the one or more processing circuits of the mobile terminal are configured to send the positioning assistance data request as one or more Control Plane (CP) messages to a serving base station in the wireless communication network requesting OTDOA assistance data for the mobile terminal from the serving base station.

15. The mobile terminal of claim 14, wherein the one or more control circuits of the mobile terminal are configured to receive the positioning assistance data as one or more CP messages that include physical cell identifications (PCIs) for a number of candidate cells in the wireless communication network, and further include transmission timing information for the candidate cells relative to serving cell transmission timing, wherein the serving cell corresponds to the serving base station.

16. The mobile terminal of claim 9, further comprising a memory storing a security key, and wherein the one or more processing circuits of the mobile terminal are configured to include the security key, or a derived value based on the security key, in the positioning assistance data request, to thereby satisfy network-imposed access restrictions to the requested positioning assistance data.

17. A method in a wireless communication network base station of supporting mobile positioning operations, the method comprising:
receiving a positioning assistance data request from a mobile terminal over a Control Plane (CP) connection with the mobile terminal;
determining positioning assistance data for the mobile terminal in response to the positioning assistance data request; and
sending the positioning assistance data to the mobile terminal over the CP connection.

18. The method of claim 17, wherein determining the position assistance information comprises selectively determining the positioning request based on verifying authentication data included in the positioning assistance data request, and wherein sending the positioning assistance data to the mobile terminal is conditioned on successful verification of the authentication data.

19. The method of claim 17, wherein the positioning assistance data request comprises a request for Observed Time Difference of Arrival (OTDOA) assistance data received via one or more Control Plane (CP) messages from the mobile terminal, and wherein determining the positioning assistance data comprises determining or obtaining OTDOA assistance data for the mobile terminal, for the base station as the mobile terminal's serving cell, and for base stations in one or more neighboring candidate cells, said OTDOA assistance data including physical cell identifications (PCIs) for the candidate cells and transmission timing information for the candidate cells relative to serving cell transmission timing.

20. The method of claim 19, wherein the base station obtains at least some of the OTDOA assistance data from the candidate cells via inter-base-station communications between the base station and the base stations in the one or more neighboring candidate cells.

21. The method of claim 19, wherein the base station sends the OTDOA assistance data to the mobile terminal as the positioning assistance data, via one or more CP messages sent from the base station to the mobile terminal.

22. A base station for use in a wireless communication network, said base station configured to support mobile positioning operations and comprising:
a wireless communication transceiver for sending wireless communication signals to mobile terminals and receiving wireless communication signals from mobile terminals;
a base station interface for inter-base-station communications with other base stations; and
one or more processing circuits operatively associated with the wireless communication transceiver and configured to:
receive a positioning assistance data request from a mobile terminal over a Control Plane (CP) connection with the mobile terminal;
determine positioning assistance data for the mobile terminal in response to the positioning assistance data request; and
send the positioning assistance data to the mobile terminal over the CP connection.

23. The base station of claim 22, wherein the one or more processing circuits of the base station are configured to determine the positioning assistance data selectively, based on verifying authentication data included in the positioning assistance data request, and to send the positioning assistance data to the mobile terminal conditioned on successful verification of the authentication data.

24. The base station of claim 22, wherein the positioning assistance data request comprises a request for Observed Time Difference of Arrival (OTDOA) assistance data received via one or more CP messages from the mobile terminal, and wherein the one or more processing circuits of the base station are configured to determine the positioning assistance data based on determining or obtaining OTDOA assistance data for the mobile terminal, for the base station as the mobile terminal's serving cell, and for base stations in one or more neighboring candidate cells, said OTDOA assistance data including physical cell identifications (PCIs) for the candidate cells and transmission timing information for the candidate cells relative to serving cell transmission timing.

25. The base station of claim 24, wherein the base station is configured to obtain at least some of the OTDOA assistance data from the candidate cells via inter-base-station communications carried between the base station and the base stations in the one or more neighboring cells on the base station interface.

26. The base station of claim 24, wherein the base station is configured to send the OTDOA assistance data to the mobile terminal as the positioning assistance data, via one or more CP messages sent from the base station to the mobile terminal.
